(19) United States
(12) Patent Application Publication
(10) Pub. No.: US 2026/0320146 A1
(43) Pub. Date: Oct. 15, 2026

(54) ELECTRONIC DEVICE AND METHOD FOR REMOVING CONTENT IN WEB PAGE

(71) Applicant: Samsung Electronics Co., Ltd., Suwon-si (KR)

(72) Inventor: Junbong EOM, Suwon-si (KR)

(21) Appl. No.: 19/647,274

(22) Filed: Apr. 14, 2026

Related U.S. Application Data
(63) Continuation of application No. PCT/KR2024/096252, filed on Oct. 10, 2024.

(30) Foreign Application Priority Data
Oct. 17, 2023 (KR) 10-2023-0138345
Dec. 1, 2023 (KR) 10-2023-0172356

(51) Int. Cl. G06F 16/958; G06F 16/955

(52) U.S. Cl. CPC G06F 16/958; G06F 16/955

(57) ABSTRACT

A method for removing content in a web page in an electronic device is provided. The method includes removing, from a web server, a web page being displayed or to be displayed on a screen of the electronic device, analyzing the web page, identifying, based on the analysis, at least one frame satisfying at least one condition among one or more frames in the web page, and removing the at least one frame or content in the at least one frame from the web page, wherein the at least one condition comprises at least one of whether a position of each of the at least one frame on the screen is fixed with respect to a scroll input to the web page or whether a domain address of a universal resource locator (URL) of the identified frame is different from a domain address of a URL of the web page.

### CROSS-REFERENCE TO RELATED APPLICATION(S)

This application is a continuation application, claiming priority under 35 U.S.C. § 365(c), of an International application No. PCT/KR2024/096252, filed on Oct. 10, 2024, which is based on and claims the benefit of a Korean patent application number 10-2023-0138345, filed on Oct. 17, 2023, in the Ministry of Intellectual Property (MOIP), and of a Korean patent application number 10-2023-0172356, filed on Dec. 1, 2023, in the Ministry of Intellectual Property (MOIP), the disclosure of each of which is incorporated by reference herein in its entirety.

### BACKGROUND

### 1. Field

The disclosure relates to an electronic device and method for removing content in a web page. More particularly, the disclosure relates to an electronic device and method for identifying removal target content in a web page and preventing the removal target content from being displayed within the web page.

### 2. Description of Related Art

With the advancement of network and multimedia technologies, users have been able to utilize various services provided through web pages of web browsers. In addition, with the increasing prevalence and use of the Internet, a large amount of contents are being provided through the web pages, and most websites are providing information to the users and encouraging an increase of the number of users who use the websites. This increase of the website users has led to an increase of the exposure of advertisements and commercial contents to users. However, the advertisements and commercial contents are information unnecessary for the website users, and cause an inconvenience to the users in a web browsing environment. Conventionally, to prevent unnecessary contents from being exposed through the web pages, technologies for separately managing universal resource locator (URL) lists that provide the unnecessary contents have been provided, but require the frequent update of the URL lists and have difficulties in efficient maintenance and management of the URL lists.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and method for removing content in a web page.

Additional aspects will be set forth in part in the description which follows and, in part, will be apparent from the description, or may be learned by practice of the presented embodiments.

In accordance with an aspect of the disclosure, a method for removing content in a web page in an electronic device is provided. The method includes the operations of removing, from a web server, a web page being displayed or to be displayed on a screen of the electronic device, analyzing the web page, identifying, based on the analysis, at least one frame satisfying at least one condition among one or more frames in the web page, and removing the at least one frame or content in the at least one frame from the web page, wherein the at least one condition includes at least one of whether the position of each of the at least one frame on the screen is fixed with respect to a scroll input to the web page or whether a domain address of a universal resource locator (URL) of the identified frame is different from a domain address of a URL of the web page.

In accordance with another aspect of the disclosure, an electronic device for removing content in a web page is provided. The electronic device includes a display, memory, comprising one or more storage media, storing instructions, and one or more processors operatively connected to the display and the memory, wherein the instructions, when executed by the one or more processors individually or collectively, cause the electronic device to remove, from a web server, a web page being displayed or to be displayed on a screen of the electronic device, analyze the web page, identify, based on the analysis, at least one frame satisfying at least one condition among one or more frames in the web page, and remove the at least one frame or content in the at least one frame from the web page, and wherein the at least one condition includes at least one of whether the position of each of the at least one frame on the screen is fixed with respect to a scroll input to the web page or whether a domain address of a universal resource locator (URL) of the identified frame is different from a domain address of a URL of the web page.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include removing, from a web server, a web page being displayed or to be displayed on a screen of the electronic device, analyzing the web page, identifying, based on the analysis, at least one frame satisfying at least one condition among one or more frames in the web page, and removing the at least one frame and/or content in the at least one frame from the web page, wherein the at least one condition includes at least one of whether a position of each of the at least one frame on the screen is fixed with respect to a scroll input to the web page or whether a domain address of a universal resource locator (URL) of the identified frame is different from a domain address of a URL of the web page.

In accordance with another aspect of the disclosure, a method for removing advertisement content in a web page in an electronic device is provided. The method includes the operations of obtaining code information of the web page to be displayed on a screen of the electronic device, identifying a frame whose position on the screen is fixed although a scroll input to the web page is received among frames in the web page, based on the code information of the web page, identifying whether a domain address of the identified frame is different from a domain address of the web page, based on the code information of the web page, and removing the frame and advertisement content in the frame within the web page, as the domain address of the identified frame is different from the domain address of the web page.

In accordance with another aspect of the disclosure, a method for removing advertisement content in a web page in an electronic device is provided. The method includes the operations of obtaining code information of the web page to be displayed on a screen of the electronic device, identifying an attribute of a frame in the web page, based on the code information of the web page, determining whether to remove the frame and the content, based on the attribute of the frame and the attribute of the content, and removing the frame and the content from the web page, based on the determination.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an example of removing content in a specific frame included within a web page on a screen of an electronic device in the electronic device, according to an embodiment of the disclosure;

FIG. 2 is a flowchart illustrating a method for removing content in a specific frame included within a web page in an electronic device, according to an embodiment of the disclosure;

FIG. 3 is a flowchart illustrating a method for removing content in a frame, based on an attribute of the frame and an attribute of content in the frame, in an electronic device, according to an embodiment of the disclosure;

FIG. 4 is a flowchart illustrating a method for identifying an attribute of a frame in a web page in an electronic device, according to an embodiment of the disclosure;

FIG. 5 is a diagram illustrating an example of fixing the position of a frame in a web page in response to a scroll input to the web page, according to an embodiment of the disclosure;

FIG. 6 is a diagram illustrating an example of determining whether a frame including removal target content is a subframe, based on code of a web page, according to an embodiment of the disclosure;

FIG. 7 is a diagram illustrating an example of comparing a domain corresponding to a frame including removal target content with a domain of a web page, based on code of the web page, according to an embodiment of the disclosure;

FIG. 8 is a flowchart illustrating a method for identifying an attribute of content in a web page in an electronic device, according to an embodiment of the disclosure;

FIG. 9 is a diagram illustrating an example of identifying an attribute related to a link connected to removal target content, according to an embodiment of the disclosure;

FIG. 10 is a diagram illustrating an example of not providing a scroll function for removal target content, according to an embodiment of the disclosure;

FIG. 11 is a diagram illustrating an example in which removal target content includes an object for frame removal, according to an embodiment of the disclosure;

FIG. 12 is a flowchart illustrating a method for removing content in a frame, based on an attribute of a content block and an attribute of content in the content block, in an electronic device, according to an embodiment of the disclosure; and

FIG. 13 is a block diagram of an electronic device 1301 in a network environment 1300, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, terms such as first, second, etc. may be used for describing various components, but the components should not be limited by these terms. These terms are used for the purpose of distinguishing one component from another component.

Throughout the specification, when a certain portion is “connected” to another portion, it includes not only being “directly connected” but also being “electrically connected” with another element arranged therebetween. In addition, when a certain portion “includes” a certain component, it means not excluding another component but rather being able to further include another component, unless specifically stated otherwise.

Phrases such as “in an embodiment,” etc. appearing in various places in the disclosure do not necessarily all refer to the same embodiment.

An embodiment of the disclosure may be represented by functional block configurations and various processing operations. Some or all of these functional blocks may be implemented by various numbers of hardware and/or software configurations performing specific functions. For example, the functional blocks of the disclosure may be implemented by one or more microprocessors, or be implemented by circuit configurations for a predefined function. In addition, for example, the functional blocks of the disclosure may be implemented by various programming or scripting languages. The functional blocks may be implemented by algorithms that are executed by one or more processors. In addition, the disclosure may employ the prior art for the sake of electronic configuration, signal processing, data processing, etc. Terms such as “mechanism,” “element,” “means,” “configuration,” etc. may be used broadly, and are not limited to mechanical and physical configurations.

In addition, connection lines or connection members between components illustrated in the drawings merely represent functional connections and/or physical or circuit connections, as examples. In an actual device, connections between the components may be represented by various replaceable or added functional connections, physical connections, or circuit connections.

The disclosure will be described in detail below with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

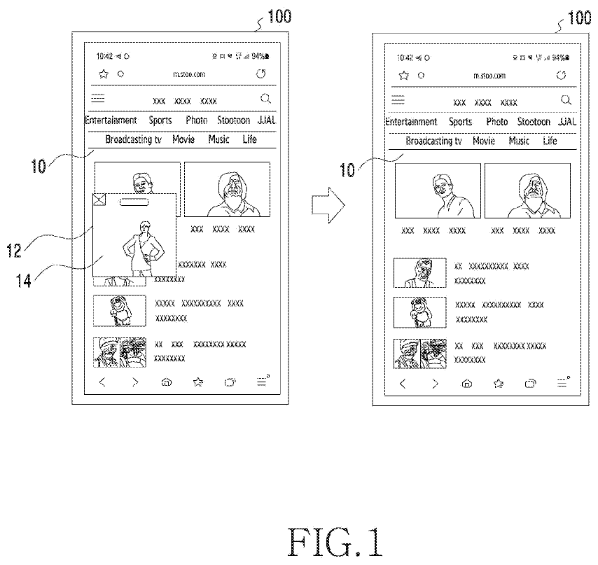

FIG. 1 is a diagram illustrating an example of removing content in a specific frame included within a web page on a screen of an electronic device in the electronic device, according to an embodiment of the disclosure.

Referring to FIG. 1, a web page 10 may be displayed on a screen of an electronic device 100, and content 14 being a removal target may be displayed within a frame 12 in the web page 10. The removal target content 14 may be content not related or less related to content of the web page 10. For example, the removal target content 14 may be advertisement content, but is not limited thereto.

Before or after displaying the web page, the electronic device 100 may determine whether the content 14 is removal target content, based on code information (e.g., document on hypertext markup language (HTML) and document on the World Wide Web) of the web page. The electronic device 100 may determine whether the content 14 is the removal target content, based on an attribute of the frame 12 including the content 14 being the removal target and an attribute of the content 14. The electronic device 100 may evaluate the content 14, based on weights corresponding to the attributes of the frame 12 including the content 14. In addition, when the electronic device 100 may not determine whether the content 14 is the removal target by solely the result of evaluation of the content 14 being based on the attribute of the frame 12 including the content 14, the electronic device 100 may evaluate the content 14 by additionally considering weights corresponding to attributes of the content 14.

When it is determined that the content 14 is the removal target, the electronic device 100 may prevent the content 14 from being displayed within the web page 10 displayed on the screen of the electronic device 100. Before displaying the web page 10 on the screen of the electronic device 100, the electronic device 100 may determine in real time whether the content 14 is the removal target, and may display the web page 10 from which the removal target content 14 has been removed, on the screen of the electronic device 100. Alternatively, the electronic device 100 may display the web page 10 from which the content 14 has not been removed, and when a user input (e.g., scroll input) to the web page 10 is received, the electronic device 100 may easily remove the display of the content 14 from the screen of the electronic device 100 on which the web page 10 is displayed.

The electronic device 100 may be a smart phone, a tablet PC, a personal computer (PC), a smart television (TV), a mobile phone, a personal digital assistant (PDA), a laptop computer, a media player, a micro server, a global positioning system (GPS) device, an e-book reader, a digital broadcasting terminal, a navigation device, a kiosk, an moving picture experts group audio layer 3 (MP3) player, a digital camera, a home appliance, and other mobile or non-mobile computing devices, but is not limited thereto. In addition, the electronic device 100 may be a wearable device, such as a watch, glasses, a hair band, a ring, etc., having a communication function and a data processing function. However, the electronic device 100 is not limited thereto, and the electronic device 100 may include all types of devices capable of displaying a web page obtained via a network.

The network may include a combination of at least two or more of a local area network (LAN), a wide area network (WAN), a value added network (VAN), a mobile radio communication network, or a satellite communication network, and may be a data communication network of a comprehensive meaning capable of causing the electronic device 100 to communicate seamlessly with other devices, and may include wired Internet, wireless Internet, and a mobile radio communication network. The wireless communication may be wireless LAN (Wi-Fi), Bluetooth, Bluetooth low energy, Zigbee, Wi-Fi direct (WFD), ultra wideband (UWB), infrared communication (infrared data association (IrDA)), near field communication (NFC), etc., but is not limited thereto.

The above description has been made in which the electronic device 100 removes content 14 in a frame 12 in a web page 10, but a target removed from the web page 10 is not limited to the content 14 in the frame 12. For example, the electronic device 100 may also remove an element that may be independently distinguished within the web page. The element that may be independently distinguished within the web page may be, for example, an element defined by an “iframe” tag and/or a “div” tag in HTML source code.

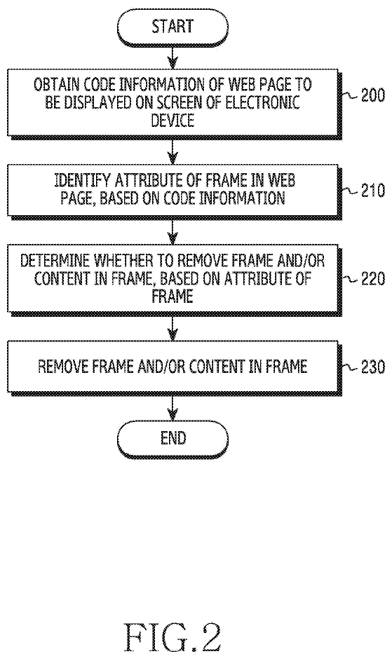

FIG. 2 is a flowchart illustrating a method for removing content in a specific frame included within a web page in an electronic device, according to an embodiment of the disclosure.

Referring to FIG. 2, in operation 200, an electronic device 100 may obtain code information of a web page to be displayed on a screen of the electronic device 100. The electronic device 100 may obtain code information of a web page to be displayed or displayed on the screen of the electronic device 100. The code information of the web page may be source code information of the web page, and may include, for example, source code of hypertext markup language (HTML). The source code of HTML may be text, and may include, for example, a tag value and an attribute value related to the tag value, but is not limited thereto. The electronic device 100 may obtain the code information of the web page to be displayed on the screen of the electronic device 100, based on a user input of calling a specific web page in an Internet browser. For example, the electronic device 100 may obtain the code information of the web page, in response to at least one of a user input of inputting a specific address to an address bar of the Internet browser or a user input of selecting an object linked to a specific web page.

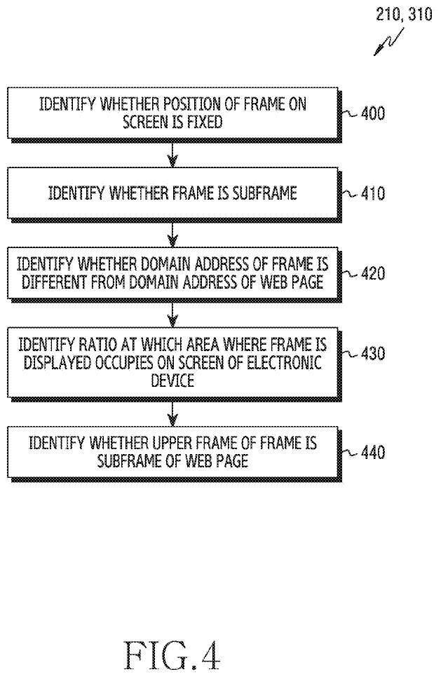

In operation 210, the electronic device 100 may identify an attribute of a frame in the web page, based on the code information. The electronic device 100 may identify the attribute of the frame in the web page and an attribute of a parent element of the frame, based on the code information. The electronic device 100 may identify attributes of the frame in the web page, based on codes in HTML information. The attribute of the frame in the web page may include, for example, an attribute regarding whether the position of the frame on the screen is fixed, an attribute regarding whether a domain address of the frame is different from a domain address of the web page, an attribute regarding a ratio at which an area where the frame is displayed occupies on the screen of the electronic device 100, an attribute regarding whether the frame is a subframe of the uppermost frame of the web page, and an attribute regarding whether an upper frame of the frame is a subframe of the web page. A method for identifying the attribute of the frame in the electronic device 100 will be described in more detail with reference to FIG. 4.

In operation 220, the electronic device 100 may determine whether to remove the frame and/or content in the frame, based on the attribute of the frame. The electronic device 100 may identify a weight corresponding to each of the attributes of the frame by attributes, and calculate a weight score for the frame, based on the identified weight. The electronic device 100 may calculate the weight score for the frame, based on at least one of the attributes of the frame. For example, when the position of the frame on the screen is fixed although a scroll input to the web page is received, the electronic device 100 may assign a first weight to the frame. For example, when a domain address of the frame is different from a domain address of the web page, the electronic device 100 may assign a second weight to the frame. For example, when a ratio at which an area where the frame is displayed occupies on the screen of the electronic device 100 is greater than or equal to a threshold, the electronic device 100 may assign a third weight to the frame. For example, when the frame is a subframe of the uppermost frame of the web page, the electronic device 100 may assign a fourth weight to the frame. For example, when an upper frame of the frame is a subframe of the web page, the electronic device 100 may assign a fifth weight to the frame. In addition, for example, the electronic device 100 may calculate the weight score for the frame, based on at least one of the first weight, the second weight, the third weight, the fourth weight, or the fifth weight. In this case, when considering some of the first weight, the second weight, the third weight, the fourth weight, and the fifth weight, the electronic device 100 may identify only the attribute of the frame related to the considered weight.

According to an embodiment, when the weight score for the frame is greater than or equal to a threshold, the electronic device 100 may determine that the frame and/or the content in the frame are removal targets. According to an embodiment, when the frame has a preset attribute, the electronic device 100 may also determine that the frame and/or the content in the frame are the removal targets. According to an embodiment, the electronic device 100 may determine, as a removal target, at least one of the frame, the content (e.g., element) in the frame, or parent content (e.g., parent element) of the frame.

In operations 210 and 220, it has been described that the electronic device 100 determines whether to remove the frame and/or the content in the frame, based on the attribute of the frame in the web page, but it is not limited thereto. For example, the electronic device 100 may determine whether to remove at least one of an element, content in the element, or a parent element of the element, based on an attribute of the element in the web page. The element may be, for example, an element defined by an “iframe” tag and/or a “div” tag in HTML source code, but is not limited thereto. The element may include, for example, a frame and/or a content block.

According to an embodiment, by analyzing the code information of the web page, the electronic device 100 may identify whether the frame in the web page and/or the content in the frame satisfy at least one predefined condition, in order to determine whether the frame in the web page and/or the content are removal targets. In this case, the at least one predefined condition may be a condition related to the attribute of the frame in operation 210. In addition, a weight may be assigned to each of the at least one predefined condition. In addition, analyzing the code information of the web page may include analyzing a tag value in source code of the web page and an attribute value related to a tag.

In operation 230, the electronic device 100 may remove the frame and/or the content in the frame. By modifying code related to the display of the frame and/or the content in the frame, the electronic device 100 may remove the frame and/or the content in the frame within the web page. For example, by modifying code for displaying the frame and the content being the removal targets among codes included in HTML, the electronic device 100 may prevent the frame and/or the content in the frame from being displayed within the web page. For example, the electronic device 100 may modify a code value, which indicates the size of a frame including removal target content, to ‘0.’ For example, the electronic device 100 may modify a display attribute value for the content and/or the frame being the removal targets, to ‘none.’ According to an embodiment, the electronic device 100 may remove the frame and/or the content in the frame, based on a user input. For example, the electronic device 100 may instruct a displayed frame on screen movement, and remove content in the frame, based on a scroll input. The above description has been made in which the electronic device 100 removes the frame and/or the content in the frame, but a target removed from the web page is not limited to the frame and/or the content in the frame. For example, the electronic device 100 may also remove an element that may be independently distinguished within the web page. The element that may be independently distinguished within the web page may be, for example, an element defined by an “iframe” tag and/or a “div” tag in HTML source code.

According to an embodiment, the electronic device 100 may remove an upper element of an element including removal target content, together with the element including the removal target content.

For example, when the element including the removal target content is a child element, an upper element of the element including the removal target content is a parent element of the child element being a removal target, and a ratio at which an area where the child element is displayed occupies within the parent element is greater than or equal to a threshold, the electronic device 100 may remove the parent element and the child element within the web page, together. In this case, the elements may be, for example, elements defined by an “iframe” tag and/or a “div” tag in HTML source code.
<div>
   <div>
      <div>
         <div>
         <iframe>
         <iframe>

For example, when the web page includes elements having the above hierarchical structure, if it is determined that the element of line 6 is a removal target, the electronic device 100 may determine that the elements of lines 3 to 5, which are parent elements of the element of line 6, are removal targets. In this case, the element of line 6 may have a relationship of only child with the elements of lines 3 to 5.

In addition, since the element of line 3 does not have a relationship of only child with the element of line 1, the electronic device 100 may compare the size of the element of line 1 with the size of the element of line 3. When a ratio of the size of the element of line 3 to the size of the element of line 1 is greater than or equal to a predefined threshold, the electronic device 100 may determine the element of line 1 as a removal target. Alternatively, when the ratio of the size of the element of line 3 to the size of the element of line 1 is smaller than the predefined threshold, the electronic device 100 may determine the element of line 3 as a removal target.

For example, when a frame including removal target content is a child frame, an upper frame of the frame including the removal target content is a parent frame of the frame being a removal target, and a ratio at which an area where the child frame is displayed occupies within the parent frame is greater than or equal to a threshold, the electronic device 100 may remove the parent frame and the child frame within the web page, together.

According to an embodiment, when an event of calling a web page occurs, the electronic device 100 may first display the web page from which removal target content has not been removed. In this case, for example, when a preset time elapses after the displaying of the web page from which the removal target content has not been removed, the electronic device 100 may display the web page from which the removal target content has been removed. Alternatively, for example, after displaying the web page from which the removal target content has not been removed, the electronic device 100 may remove the display of the removal target content from the web page, in response to receiving a preset user input (e.g., scroll input) to the web page.

Alternatively, for example, after displaying the web page from which the removal target content has not been removed, the electronic device 100 may display a graphical user interface (GUI) of inquiring whether to remove the removal target content, on the screen of the electronic device 100, and in response to receiving a user input to the GUI, the electronic device 100 may display the web page from which the removal target content has been removed. Alternatively, for example, after displaying the web page from which the removal target content has not been removed, the electronic device 100 may display the web page from which the removal target content has been removed, in response to receiving a user input for screen movement.

According to an embodiment, the electronic device 100 may alternately display the web page from which the removal target content has not been removed and the web page from which the removal target content has been removed. For example, when the electronic device 100 reloads the web page odd times, the electronic device 100 may display the web page from which the removal target content has been removed, and when the electronic device 100 reloads the web page even times, the electronic device 100 may display the web page from which the removal target content has not been removed.

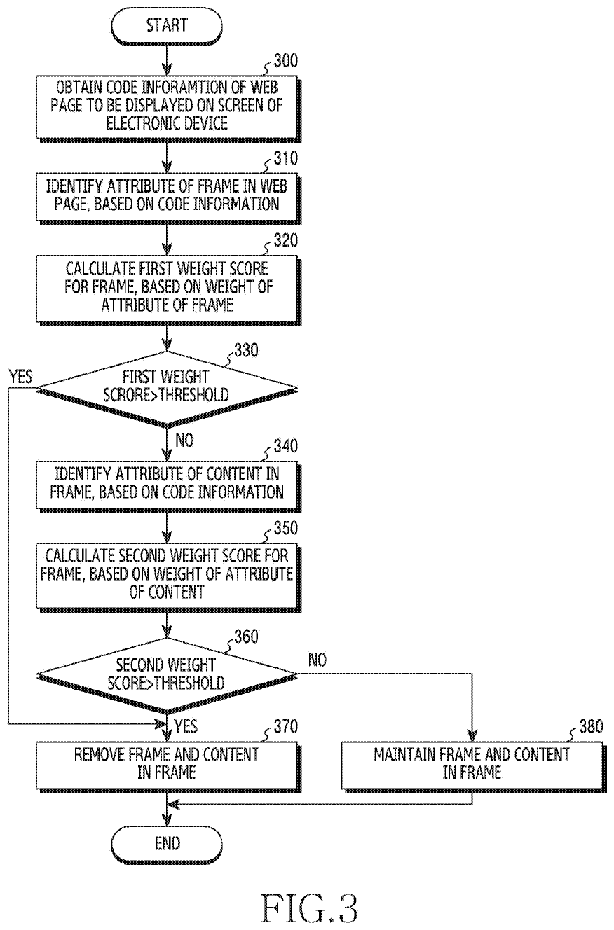

FIG. 3 is a flowchart illustrating a method for removing content in a frame, based on an attribute of the frame and an attribute of content in the frame, in an electronic device, according to an embodiment of the disclosure.

Since operations 300 and 310 of FIG. 3 correspond to operations 200 and 210 of FIG. 2, a description of operations 300 and 310 will be omitted for convenience.

Referring to FIG. 3, in operation 320, the electronic device 100 may calculate a first weight score for a frame, based on a weight of an attribute of the frame. The electronic device 100 may identify a weight corresponding to each of the attributes of the frame by attributes, and calculate the first weight score for the frame, based on the identified weight. The electronic device 100 may calculate the first weight score for the frame, based on at least one of the attributes of the frame. For example, when the position of the frame on a screen is fixed although a scroll input to a web page is received, the electronic device 100 may assign a first weight to the frame. For example, when a domain address of the frame is different from a domain address of the web page, the electronic device 100 may assign a second weight to the frame. For example, when a ratio at which an area where the frame is displayed occupies on the screen of the electronic device 100 is greater than or equal to a threshold, the electronic device 100 may assign a third weight to the frame. For example, when the frame is a subframe of the uppermost frame of the web page, the electronic device 100 may assign a fourth weight to the frame. For example, when an upper frame of the frame is a subframe of the web page, the electronic device 100 may assign a fifth weight to the frame. In addition, for example, the electronic device 100 may calculate the first weight score for the frame, based on at least one of the first weight, the second weight, the third weight, the fourth weight, or the fifth weight. In this case, when considering some of the first weight, the second weight, the third weight, the fourth weight, and the fifth weight, the electronic device 100 may identify only the attribute of the frame related to the considered weight.

In operation 330, the electronic device 100 may determine whether the first weight score is greater than a threshold. According to an embodiment, when the first weight score is greater than the threshold as the determination result of operation 330, the electronic device 100 may perform operation 370, which will be described later.

According to an embodiment, when the first weight score is less than the threshold as the determination result of operation 330, the electronic device 100 may, in operation 340, identify an attribute of content in the frame, based on the code information. The electronic device 100 may identify attributes of the content in the frame in the web page, based on codes in HTML information. The attributes of the content in the frame may include, for example, at least one of an attribute regarding whether other content linked to the content in the frame is displayed through a new window, an attribute regarding whether a domain address of the other content linked to the content in the frame is different from a domain address of the web page, an attribute of a link to the content in the frame, an attribute regarding a ratio at which an area where the content is displayed occupies within the frame, an attribute regarding whether the content is scrollable within the frame, and an attribute regarding whether the content includes an object for frame removal.

According to an embodiment, the electronic device 100 may identify an attribute of a parent frame of the frame in the web page. For example, when a parent frame of a certain frame has a “fixed” attribute, the frame may also have the “fixed” attribute. In this case, by identifying the attribute of the parent frame, the electronic device 100 may identify the attribute of the frame.

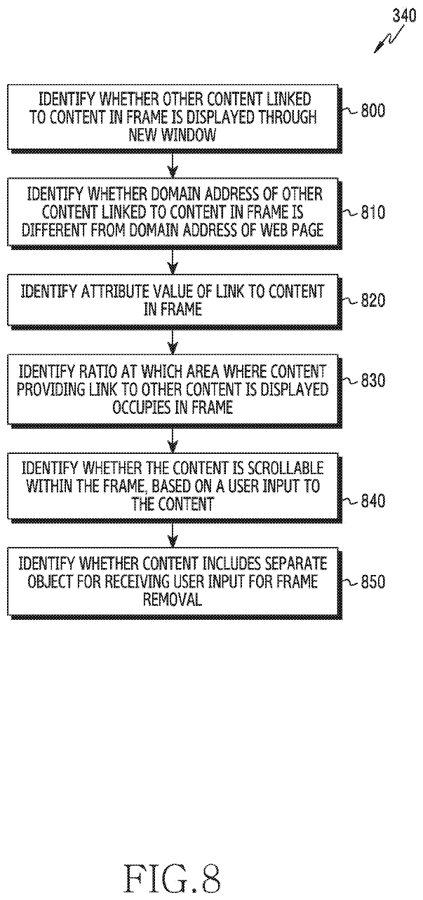

A method for identifying the attribute of the content in the frame in the electronic device 100 will be described in more detail with reference to FIG. 8.

In operation 350, the electronic device 100 may calculate a second weight score for the frame, based on a weight for the attribute of the content. The electronic device 100 may identify a weight corresponding to each of the attributes of the content in the frame by attributes, and calculate the second weight score for the frame, based on the identified weight. According to an embodiment, by adding the weight corresponding to the attribute of the content to the first weight score for the frame, the electronic device 100 may calculate the second weight score for the frame.

For example, when the other content linked to the content in the frame is displayed through a new window, the electronic device 100 may assign a sixth weight to the frame. For example, when a domain address of the other content linked to the content in the frame is different from a domain address of the web page, the electronic device 100 may assign a seventh weight to the frame. For example, in accordance with an attribute value of a link to the content in the frame, the electronic device 100 may assign an eighth weight to the frame. For example, in accordance with a ratio at which an area where the content is displayed occupies within the frame, the electronic device 100 may assign a ninth weight to the frame. For example, when the content is not scrollable within the frame, the electronic device 100 may assign a tenth weight to the frame. For example, when the content includes an object for frame removal, the electronic device 100 may assign an eleventh weight to the frame.

In addition, for example, by adding at least one of the sixth weight, the seventh weight, the eighth weight, the ninth weight, the tenth weight, or the eleventh weight to the first weight score for the frame, the electronic device 100 may calculate the second weight score for the frame. In this case, when considering some of the sixth weight, the seventh weight, the eighth weight, the ninth weight, the tenth weight, or the eleventh weight, the electronic device 100 may identify only the attribute of the content related to the considered weight.

In operation 360, the electronic device 100 may determine whether the second weight score is greater than a threshold. The threshold compared to the second weight score in operation 360 may be the same as the threshold compared to the first weight score in operation 330, but is not limited thereto.

According to an embodiment, when the second weight score is greater than the threshold as the determination result of operation 360, the electronic device 100 may, in operation 370, remove the frame and the content in the frame from the web page.

According to an embodiment, by modifying code related to the display of the frame and the content in the frame, the electronic device 100 may remove the frame and the content in the frame within the web page. For example, by modifying code for displaying the frame and the content being removal targets among codes included in HTML, the electronic device 100 may prevent the frame and the content in the frame from being displayed within the web page. For example, the electronic device 100 may modify a code value, which indicates the size of the frame including the removal target content, to ‘0.’ For example, the electronic device 100 may modify a display attribute value for the content and the frame being the removal targets, to ‘none.’ For example, by moving the display positions of the frame and the content being the removal targets to the outside of the screen of the electronic device 100, the electronic device 100 may prevent the frame and the content in the frame from being displayed within the web page. Alternatively, for example, by moving the display positions of the frame and the content being the removal targets to an edge portion of the screen of the electronic device 100, the electronic device 100 may prevent the frame and the content in the frame from being displayed within the web page.

According to an embodiment, the electronic device 100 may remove an upper frame of a frame including removal target content, together with the frame including the removal target content. For example, when the frame including the removal target content is a child frame, and the upper frame of the frame including the removal target content is a parent frame of the frame being a removal target, the electronic device 100 may remove the parent frame and the child frame within the web page, together.

For example, when the frame including the removal target content is the child frame, the upper frame of the frame including the removal target content is the parent frame of the frame being the removal target, and the parent frame has a ‘fixed’ attribute, the electronic device 100 may remove the parent frame and the child frame within the web page, together.

For example, when the frame including the removal target content is the child frame, the upper frame of the frame including the removal target content is the parent frame of the frame being the removal target, and a ratio at which an area where the child frame is displayed occupies within the parent frame is greater than or equal to a threshold, the electronic device 100 may remove the parent frame and the child frame within the web page, together.

According to an embodiment, when the second weight score is less than the threshold as the determination result of operation 360, the electronic device 100 may, in operation 380, maintain the frame and the content in the frame within the web page.

According to an embodiment, before displaying the web page on the screen of the electronic device 100, the electronic device 100 may effectively determine unnecessary content, based on the code information of the web page. In addition, only when the first weight score being based on the attribute of the frame is less than the threshold, the electronic device 100 may consider the attribute of the content in the frame. Accordingly, when determining in real time and removing unnecessary content in the web page, the electronic device 100 may determine the unnecessary content more efficiently and remove the unnecessary content seamlessly within the web page.

FIG. 4 is a flowchart illustrating a method for identifying an attribute of a frame in a web page in an electronic device, according to an embodiment of the disclosure.

Operations 400 to 440 of FIG. 4 may correspond to operation 210 of FIG. 2 and operation 310 of FIG. 3.

Referring to FIG. 4, in operation 400, an electronic device 100 may determine whether the position of a frame on a screen is fixed. The electronic device 100 may identify whether the frame is displayed overlapping a web page and the position of the frame on the screen is fixed. The electronic device 100 may identify code related to a display attribute of the frame from HTML of the web page, and identify whether the frame is displayed overlapping the web page and the position of the frame on the screen is fixed, based on the identified code. For example, even when a user input of scrolling the web page is received, the frame and content in the frame may not be scrolled, although the web page is scrolled in response to the user input. In addition, the positions of the frame and the content in the frame may be fixed on the screen of the electronic device 100. In this case, the content in the frame may obscure content of information necessary for a user and thus, the user who uses the web page may feel inconvenience. Accordingly, when the position of the frame on the screen is fixed, the electronic device 100 may assign a first weight to the frame.

In operation 410, the electronic device 100 may identify whether the frame is a subframe. The electronic device 100 may determine whether the frame is a subframe of the web page, from the HTML of the web page. For example, when a corresponding frame is an iframe, the electronic device 100 may determine that the frame is a subframe. It is a high possibility that main content to be provided to the user will be included in a main frame. Accordingly, when the frame is the subframe, the electronic device 100 may assign a fourth weight to the frame.

In operation 420, the electronic device 100 may identify whether a domain address of the frame is different from a domain address of the web page. According to an embodiment, when the frame is a subframe, the electronic device 100 may identify whether the domain address of the frame is different from the domain address of the web page. The electronic device 100 may identify the domain address of the web page from the HTML of the web page, and identify the domain address of the frame in the web page. For example, when the user accesses a website called abc. com, the user expects the content of abc. com. When the electronic device 100 displays a web page of abc. com, and a domain address of a partial frame of the web page is def. com, it is a high possibility that content of the frame having the domain address of def. com is content not expected by the user. Accordingly, when the domain address of the frame is different from the domain address of the web page, the electronic device 100 may assign a second weight to the frame.

In operation 430, the electronic device 100 may identify a ratio at which an area where the frame is displayed occupies on the screen of the electronic device 100. The electronic device 100 may identify code, which indicates the size of a frame, from the HTML of the web page, and identify the ratio at which the area where the frame is displayed occupies on the screen of the electronic device 100, based on the identified code. For example, content intended to be delivered to the user through the web page generally becomes a main portion of the web page and occupies a significant portion of the entire area of the web page. For example, it is a high possibility that the content intended to be delivered to the user through the web page is a body element in the HTML. When the frame of the content occupies most of an area of the web page although not the body element of the web page, it is a high possibility that the corresponding frame includes content necessary for the user. Accordingly, when the ratio at which the area where the frame is displayed occupies on the screen of the electronic device 100 is greater than or equal to a predefined threshold, the electronic device 100 may assign a third weight to the frame. In this case, the predefined threshold compared with the ratio at which the area where the frame is displayed occupies on the screen of the electronic device 100 may be determined experimentally, but is not limited thereto.

In operation 440, the electronic device 100 may identify whether an upper frame of the frame is a subframe of the web page. The electronic device 100 may identify whether a parent frame of the frame is a subframe of the web page, from the HTML of the web page. When the parent frame of the frame is the subframe, it is a high possibility that content in the frame is not main content. Accordingly, when the upper frame of the frame is the subframe of the web page, the electronic device 100 may assign a fifth weight to the frame. According to an embodiment, when the upper frame of the frame is the subframe of the web page, the electronic device 100 may identify a depth of the frame from the web page. The depth of the frame from the web page may be determined, for example, by the number of at least one upper frame including the frame.

Meanwhile, according to an embodiment, at least some of operations 400 to 440 may be omitted in FIG. 4. In this case, for example, the electronic device 100 may calculate a first weight score for the frame, based on some of the first weight, the second weight, the third weight, the fourth weight, or the fifth weight. In addition, according to an embodiment, the order of execution of operations 400 to 440 is not limited to FIG. 4.

Meanwhile, the above description has been made in which the electronic device 100 identifies the attribute of the frame and identifies the attribute of the content in the frame, but is not limited thereto. For example, the electronic device 100 may identify the attribute of the content in the frame without identifying the attribute of the frame, and may also determine whether to remove the frame and the content in the frame, based on the attribute of the content in the frame.

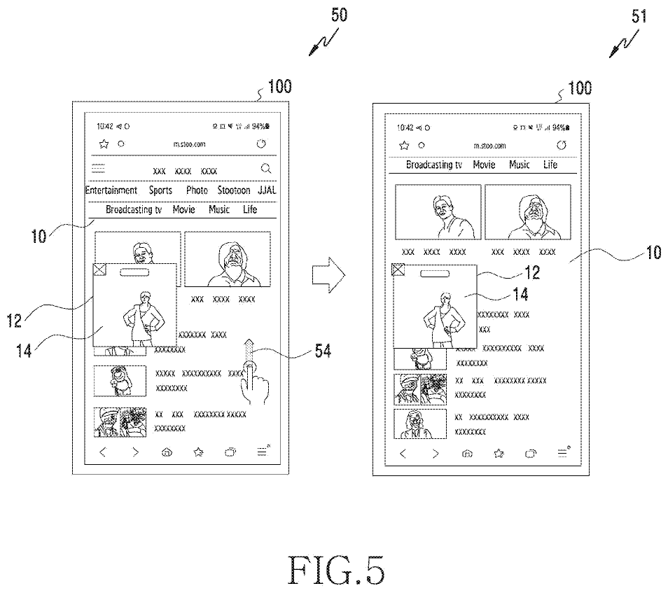

FIG. 5 is a diagram illustrating an example of fixing the position of a frame in a web page in response to a scroll input to the web page, according to an embodiment of the disclosure.

Referring to identification number 50 of FIG. 5, a web page 10 may be displayed on a screen of an electronic device 100, and the web page 10 may include a frame 12 and content 14 that are removal targets. In addition, the electronic device 100 may receive a user input 54 of scrolling the web page 10.

Referring to identification number 51 of FIG. 5, in response to the user input 54, the web page 10 may be scrolled on the screen of the electronic device 100. However, the positions of the frame 12 in the web page 10 and the content 14 in the frame 12 may not change, and may be fixed on the screen of the electronic device 100. In this case, code of HTML related to the frame 12 in the web page 10 and the content 14 in the frame 12 that are fixed on the screen may include, for example, ‘position: fixed.’

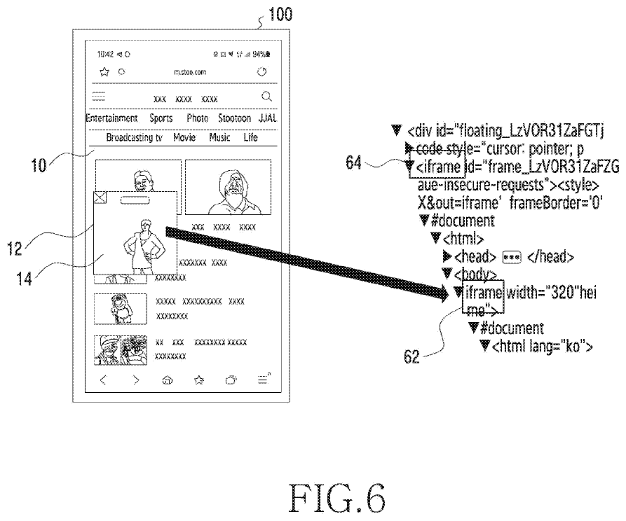

FIG. 6 is a diagram illustrating an example of determining whether a frame including removal target content is a subframe, based on code of a web page, according to an embodiment of the disclosure.

Referring to FIG. 6, a web page 10 may be displayed on a screen of an electronic device 100, and the web page 10 may include a frame 12 and content 14 that are removal targets. For example, a code value corresponding to the frame 12 is “iframe” 62, and thus, the electronic device 100 may identify that frame 12 is a subframe. In addition, the electronic device 100 may identify that a parent frame of the frame 12 is a subframe, based on a code value “iframe” 64.

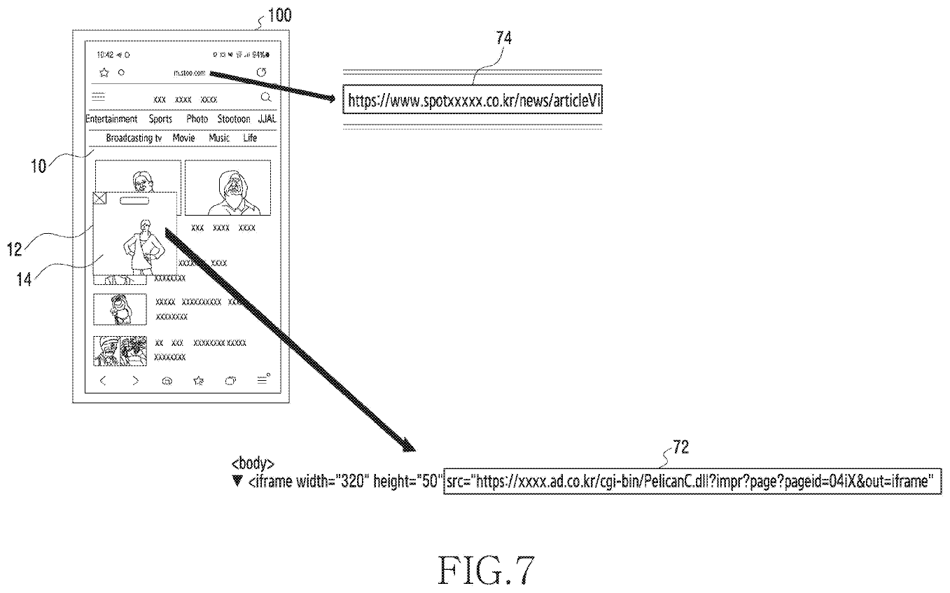

FIG. 7 is a diagram illustrating an example of comparing a domain corresponding to a frame including removal target content with a domain of a web page, based on code of the web page, according to an embodiment of the disclosure.

Referring to FIG. 7, a web page 10 may be displayed on a screen of an electronic device 100, and the web page 10 may include a frame 12 and content 14 that are removal targets. In addition, for example, the electronic device 100 may identify that a domain address of the content 14 in the frame 12 is different from a domain address of the web page 10, based on an address 72 of the content 14 in the frame 12 included in SRC information of the frame 12 and an address 74 of the web page 10. Since the domain address of the content 14 in the frame 12 is different from the domain address of the web page 10, the frame 12 and the content 14 may be determined as the removal targets.

However, for example, although the domain address of the content 14 in the frame 12 is different from the domain address of the web page 10, when a domain address related to the content 14 in the frame 12 is related to the domain address of the web page 10, the electronic device 100 may determine that the frame 12 and the content 14 are not the removal targets.
<iframe src=“abc.com”>
   <html>
      <body>
         <a href=“example.com/1.html”>

For example, when a web page of example. com includes a frame of the above structure, the electronic device 100 may determine that a domain address (abc.com) of the frame is a frame related to a domain address (example.com) of the web page, from iframe src=“abc.com.” However, the electronic device 100 may identify that the frame is a frame related to the web page, based on <a href=“example.com/1.html”> among source codes related to the frame.

FIG. 8 is a flowchart illustrating a method for identifying an attribute of content in a web page in an electronic device, according to an embodiment of the disclosure.

Operations 800 to 850 of FIG. 8 may correspond to operation 340 of FIG. 3.

Referring to FIG. 8, in operation 800, an electronic device 100 may identify whether other content linked to content in a frame is displayed through a new window. When a user input of selecting the content in the frame is received, the electronic device 100 may identify whether the other content linked to the content is displayed through a new frame different from the frame including the content. The electronic device 100 may identify code related to a display attribute of the other content linked to the content from HTML of a web page, and may identify whether the other content linked to the content is displayed through the new window, based on the identified code. When the other content linked to the content in the frame is displayed through the new window, the electronic device 100 may assign a sixth weight to the frame including the content.

In operation 810, the electronic device 100 may identify whether a domain address of the other content linked to the content in the frame is different from a domain address of the web page. The electronic device 100 may identify the domain address of the web page, and identify the domain address of the other content linked to the content in the frame, from the HTML of the web page. For example, when a user accesses a website called abc. com, the user expects content from abc. com. When the electronic device 100 displays a web page of abc. com, and a domain address of other content linked to content of a partial frame of the web page is ghi.com, it is a high possibility that the content of the frame having the domain address of ghi.com is content not expected by the user. Accordingly, when the domain address of the other content linked to the content in the frame is different from the domain address of the web page, the electronic device 100 may assign a seventh weight to the frame including the content.

In operation 820, the electronic device 100 may identify an attribute value of a link to the content in the frame. The electronic device 100 may identify code, which indicates an attribute of the link to the content in the frame, from the HTML of the web page, and assign a weight to the frame, based on the identified code. For example, when an attribute of a tag for the content in the frame includes at least one of “nofollow” or “sponsored,” the electronic device 100 may assign an eighth weight to the frame including the content.

In operation 830, the electronic device 100 may identify a ratio at which an area where content providing a link to the other content is displayed occupies within the frame. The electronic device 100 may identify the ratio at which the content having the link occupies within the frame. For example, in the case of content whose main purpose is advertising exposure, although anywhere in the frame is touched, advertising content of a link related to the content is provided and thus, the size of the area where the content including the link is displayed is nearly consistent with the size of the entire area in the frame. Accordingly, when the ratio at which the area where the content is displayed occupies within the frame is greater than or equal to a threshold, the electronic device 100 may assign a ninth weight to the frame including the content.

In operation 840, the electronic device 100 may identify whether the content is scrollable within the frame, based on a user input to the content. For example, in the case of content whose main purpose is advertising exposure, when an advertisement area in the frame is scrolled, advertisement may be scrolled instead of main content in accordance with the position of a user's touch input, and also interfere with a scroll operation according to a user input, so it is a high possibility that a scroll function for the content within the frame will not be provided. Accordingly, when the content is not scrolled within the frame in response to a user input to the content, the electronic device 100 may assign a tenth weight to the frame including the content.

In operation 850, the electronic device 100 may identify whether the content includes a separate object for receiving a user input for frame removal. For example, in the case of content whose main purpose is advertisement exposure, the frame includes an object for receiving a user input for content removal. Accordingly, when the content includes the separate object for receiving the user input for frame removal, the electronic device 100 may assign an eleventh weight to the frame including the content.

According to an embodiment, the electronic device 100 may also assign the eleventh weight to the frame including the content, in consideration of the size and display position of the object for frame removal. For example, when the size of the object is very small below a predefined threshold, and the object is displayed at an edge portion of the frame, the electronic device 100 may assign the eleventh weight to the frame including the content. According to an embodiment, for example, when the size of the object is very small below the predefined threshold, the object is displayed at the edge portion of the frame, and HTML text related to the object includes a word related to a closing function such as “close/dismiss” and has a “click event listener” for receiving a user's click event, the electronic device 100 may assign the eleventh weight to the frame including the content.

For example, by providing a virtual click event on an object for removing a frame including removal target content, the electronic device 100 may remove the frame including the removal target content from the web page.

Meanwhile, according to an embodiment, at least some of operations 800 to 850 may be omitted in FIG. 8. In this case, for example, the electronic device 100 may calculate the second weight score for the frame, based on some of the sixth weight, the seventh weight, the eighth weight, the ninth weight, the tenth weight or the eleventh weight, and the first weight score. In addition, according to an embodiment, the order of execution of operations 800 to 850 is not limited to FIG. 8.

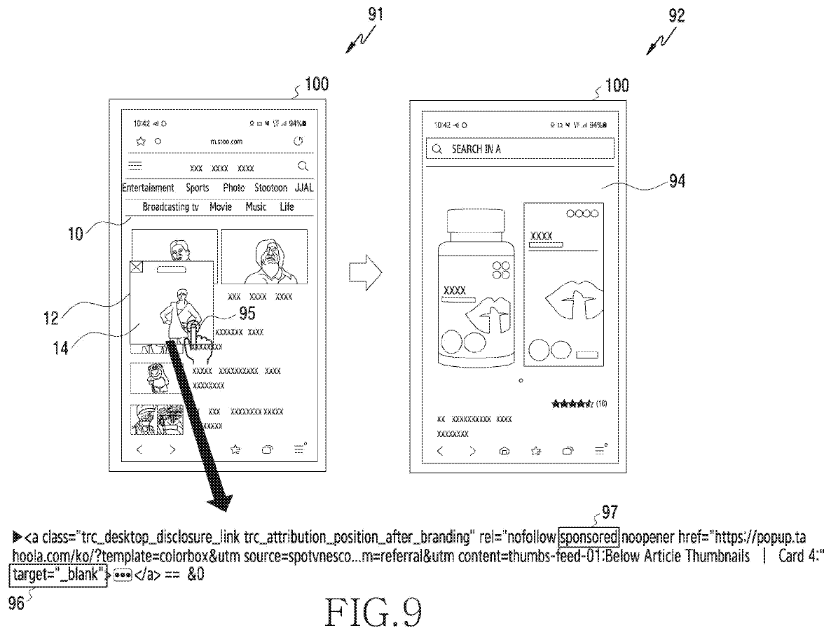

FIG. 9 is a diagram illustrating an example of identifying an attribute related to a link connected to removal target content, according to an embodiment of the disclosure.

Referring to identification number 91 of FIG. 9, a web page 10 may be displayed on a screen of an electronic device 100, and the web page 10 may include a frame 12 and content 14 that are removal targets. In addition, the electronic device 100 may receive a user input 95 of touching the content 14 in the frame 12.

Referring to identification number 92 of FIG. 9, in response to the user input 95, a new frame of advertising content 94 linked to the content 14 may be displayed on the screen of the electronic device 100.

The electronic device 100 may identify at least one of code values 96 and 97 regarding an attribute of a link linked to the content 14 from HTML of the web page, and may identify that the new frame of the advertising content 94 linked to the content 14 will be displayed on the screen of the electronic device 100, based on at least one of the identified code values 96 and 97. For example, the code value 96 may be related to an attribute of displaying a new window in response to a user's click input.

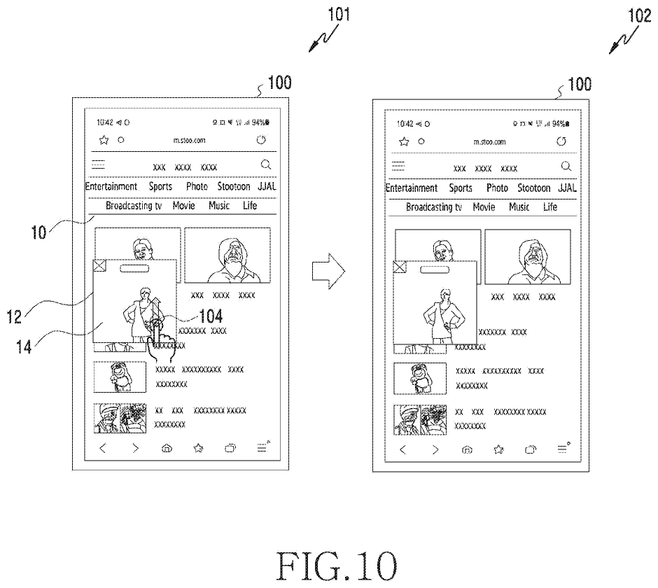

FIG. 10 is a diagram illustrating an example of not providing a scroll function for removal target content, according to an embodiment of the disclosure.

Referring to identification number 101 of FIG. 10, a web page 10 may be displayed on a screen of an electronic device 100, and the web page 10 may include a frame 12 and content 14 that are removal targets. In addition, the electronic device 100 may receive a user input 104 of scrolling the content 14 in the frame 12.

Referring to identification number 102 of FIG. 10, the electronic device 100 may ignore the user input 104 to the content 14 in the frame 12. In response to the user input 104, the content 14 in the frame 12 may not be scrolled.

For example, the content 14 in the frame 12 may not be scrolled by using a “scrolling=no” attribute in an iframe. For example, the content 14 in the frame 12 may not be scrolled by making the size of an area where the content 14 is displayed in the iframe smaller than or equal to the size of the iframe.

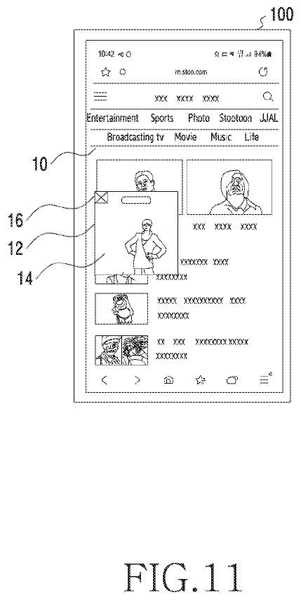

FIG. 11 is a diagram illustrating an example in which removal target content includes an object for frame removal, according to an embodiment of the disclosure.

Referring to FIG. 11, a web page 10 may be displayed on a screen of an electronic device 100, and the web page 10 may include a frame 12 and content 14 that are removal targets. In addition, the frame 12 may include a separate object 16 for removing the frame 12 and the content 14. The object 16 may be formed in a very small size in order not to obscure the content 14, and may be arranged at an edge of the frame 12. As a user input of selecting the object 16 is received, the electronic device 100 may remove the frame 12 and the content 14 within the web page 10.

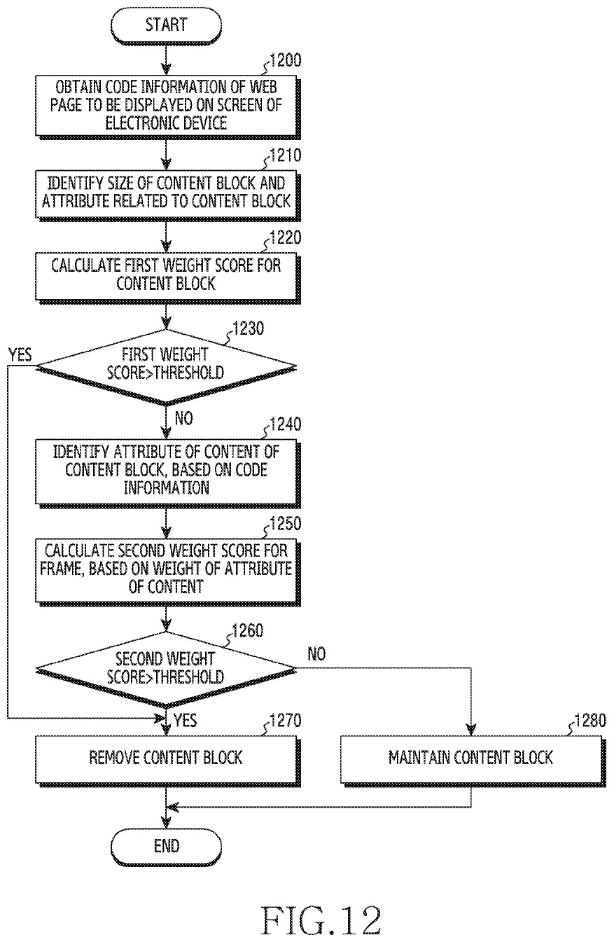

FIG. 12 is a flowchart of a method for removing a content block, based on an attribute of the content block and an attribute of content in the content block, in an electronic device, according to an embodiment of the disclosure.

Referring to FIG. 12, in operation 1200, an electronic device 100 may obtain code information of a web page to be displayed on a screen of the electronic device 100. The code information of the web page may be source code information of the web page, and may include, for example, source code of hypertext markup language (HTML). The source code of HTML may be text, and may include, for example, a tag value and an attribute value related to the tag value, but is not limited thereto. Based on a user input of calling a specific web page in an Internet browser, the electronic device 100 may obtain code information of the web page to be displayed on the screen of the electronic device 100. For example, in response to at least one of a user input of inputting a specific address to an address bar of the Internet browser or a user input of selecting an object linked to a specific web page, the electronic device 100 may obtain code information of the web page.

In operation 1210, the electronic device 100 may identify the size of a content block in the web page and an attribute related to the content block, based on the code information. The content block may be content of one unit whose edge is not surrounded by a frame. For example, the content block is displayed independently within the web page, but the edge of the content block may not be surrounded by the frame.

According to an embodiment, the electronic device 100 may identify the size of the content block in the web page and the attribute of the content block, based on codes in HTML information. For example, the electronic device 100 may identify the size of the content block and/or a display attribute of the content block. For example, the electronic device 100 may identify whether a content block having a predefined size or more has an attribute of being always displayed on the screen, and/or may identify an attribute regarding whether the content block having the predefined size or more is shown on the screen.

According to an embodiment, the electronic device 100 may identify the size of the content block in the web page and an attribute of the frame related to the content block, based on the codes in the HTML information. For example, the electronic device 100 may identify the size of the content block, and compare the size of the content block with the size of the screen of the electronic device 100. For example, the electronic device 100 may identify whether a parent frame including the content block is an upper frame or a subframe. For example, the electronic device 100 may identify whether the position of the parent frame including the content block has been fixed.

In operation 1220, the electronic device 100 may calculate a first weight score for the content block. The electronic device 100 may identify a weight corresponding to the size of the content block and a weight corresponding to the attribute of the content block, and calculate the first weight score for the content block, based on the identified weights. For example, when the position of the content block on the screen is fixed although a scroll input to the web page including the content block and/or the parent frame including the content block is received, the electronic device 100 may assign a first weight to the content block. For example, when a ratio at which an area of the content block occupies on the screen of the electronic device 100 is greater than or equal to a threshold, the electronic device 100 may assign a second weight to the content block. For example, when the content block has an attribute of being always displayed on the screen, the electronic device 100 may assign a third weight to the content block. For example, at least one of the first weight, the second weight, or the third weight may be used for calculating the first weight score.

In operation 1230, the electronic device 100 may determine whether the first weight score is greater than a threshold. According to an embodiment, when the first weight score is greater than the threshold as the determination result of operation 1230, the electronic device 100 may perform operation 1270, which will be described below.

According to an embodiment, when the first weight score is less than the threshold as the determination result of operation 1230, the electronic device 100 may, in operation 1240, identify an attribute of content of the content block, based on the code information. The electronic device 100 may identify an attribute of a child element in the content block, based on the code information. The electronic device 100 may identify attributes of the content in the content block in the web page, based on the codes in the HTML information. The attribute of the content in the content block may include, for example, at least one of an attribute regarding whether the other content linked to the content in the content block is displayed through a new window, an attribute regarding whether a domain address of the other content linked to the content in the content block is different from a domain address of the web page, an attribute of a link to the content in the content block, or an attribute regarding a ratio at which an area where the linked content is displayed occupies within the content block.

According to an embodiment, the content block may not include a subframe. In this case, the electronic device 100 may use information in the content block instead of information about the subframe. For example, when it is determined that the content block has a ‘fixed position’ attribute, the electronic device 100 may identify child information in the content block. For example, the electronic device 100 may identify information such as information about the size of the largest image in the content block, information about an attribute of src url of the largest image, information about whether the content block includes a small element that receives a user input, information about the size of the largest link element in the content block, information about whether the largest link element has a ‘target=_blank’ attribute, etc.

In operation 1250, the electronic device 100 may calculate a second weight score for the content block, based on a weight of the attribute of the content in the content block. The electronic device 100 may identify a weight corresponding to each of the attributes of the content in the content block by attributes, and calculate the second weight score for the content block, based on the identified weight. According to an embodiment, by adding the weight corresponding to the attribute of the content in the content block to the first weight score for the content block, the electronic device 100 may calculate the second weight score for the content block.

In operation 1260, the electronic device 100 may determine whether the second weight score is greater than a threshold. The threshold compared to the second weight score in operation 1260 may be the same as the threshold compared to the first weight score in operation 1230, but is not limited thereto.

According to an embodiment, when the second weight score is greater than the threshold as the determination result of operation 1260, the electronic device 100 may, in operation 1270, remove the content block from the web page.

According to an embodiment, by modifying code related to the display of the content block, the electronic device 100 may remove the content block within the web page. For example, by modifying code for displaying a removal target content block among codes included in HTML, the electronic device 100 may prevent the content block from being displayed within the web page. For example, the electronic device 100 may modify a code value indicating the size of a content block including removal target content, to ‘0.’ For example, the electronic device 100 may modify a display attribute value for the content block including the removal target content, to ‘none.’ Alternatively, for example, by providing a virtual click event for an object for removing a frame including the removal target content, the electronic device 100 may remove the frame including the removal target content from the web page.

According to an embodiment, the electronic device 100 may remove an upper frame of the content block including the removal target content, together with the removal target content block. For example, when a ratio at which the content block including the removal target content occupies within the frame including the content block is greater than or equal to a threshold, the electronic device 100 may remove the content block and the frame including the content block within the web page, together.

According to an embodiment, when the second weight score is less than the threshold as the determination result of operation 1260, the electronic device 100 may, in operation 1280, maintain the content block within the web page.

According to an embodiment, before displaying the web page on the screen of the electronic device 100, the electronic device 100 may effectively determine unnecessary content, based on the code information of the web page. In addition, only when the first weight score being based on the attribute of the content block is less than the threshold, the electronic device 100 may consider the attribute of the content in the content block. Accordingly, when determining in real time and removing unnecessary content in the web page, the electronic device 100 may determine the unnecessary content more efficiently and remove the unnecessary content seamlessly within the web page.

Meanwhile, according to an embodiment of the disclosure, the electronic device 100 may determine whether to remove a fixed element within the web page, in consideration of whether the fixed element in the web page includes a frame (e.g., iframe) as a child element.

According to an embodiment, when the fixed element in the web page includes the frame as the child element, the electronic device 100 may determine whether to remove the display of the fixed element, based on information about the frame.

According to an embodiment, when the fixed element includes the frame (e.g., iframe) that is the child element, the electronic device 100 may calculate a weight score for the content block, by identifying at least some of the attributes below related to the fixed element.

For example, when the fixed element includes the frame (e.g., iframe) that is the child element, the electronic device 100 may determine whether the fixed element is related to a third party, by identifying whether a domain address related to src of the iframe is different from a domain address of the web page and whether a domain related to the web page exists within the iframe, and may assign a specified weight to the fixed element.

For example, when the fixed element includes the frame (e.g., iframe) that is the child element, the electronic device 100 may assign a specified weight to the fixed element, by identifying whether <target=“_blank”> exists within the iframe.

For example, when the fixed element includes the frame (e.g., iframe) that is the child element, the electronic device 100 may assign a specified weight to the fixed element, by identifying whether the iframe or a parent frame (e.g., fixed parent element) of the iframe provides an object for frame removal.

For example, when the fixed element includes the frame (e.g., iframe) that is the child element, the electronic device 100 may assign a specified weight to the fixed element, by identifying whether the frame is non-scrollable.

For example, when the fixed element includes the frame (e.g., iframe) that is the child element, the electronic device 100 may assign a specified weight to the fixed element, by identifying whether the size of an area providing a link within the frame is greater than or equal to a threshold.

For example, when the fixed element includes the frame (e.g., iframe) that is the child element, the electronic device 100 may assign a specified weight to the fixed element, by identifying an attribute (e.g., “sponsored”) related to the link within the frame.

According to an embodiment, when the fixed element in the web page does not include the frame as the child element, the electronic device 100 may determine whether to remove the display of the fixed element, based on information about the child element rather than the frame included in the fixed element. For example, the electronic device 100 may determine whether to remove the display of the fixed element, based on an attribute of the largest child element in the fixed element.

According to an embodiment, when the fixed element does not include the frame (e.g., iframe) that is the child element, the electronic device 100 may calculate a weight score for the fixed element, by identifying at least some of the attributes below related to the child element rather than the frame included within the fixed element.

For example, when the fixed element does not include the frame (e.g., iframe) that is the child element, the electronic device 100 may determine whether the fixed element is related to a third party, by identifying whether a domain address not related to the web page exists within the fixed element, and may assign a specified weight to the fixed element.

For example, when the fixed element does not include the frame (e.g., iframe) that is the child element, the electronic device 100 may assign a specified weight to the fixed element, by identifying whether <target=“_blank”> exists within the fixed element.

For example, when the fixed element does not include the frame (e.g., iframe) that is the child element, the electronic device 100 may assign a specified weight to the fixed element, by identifying whether an object for frame removal exists within the fixed element.

For example, when the fixed element does not include the frame (e.g., iframe) that is the child element, the electronic device 100 may not identify whether the fixed element is non-scrollable.

For example, when the fixed element does not include the frame (e.g., iframe) that is the child element, the electronic device 100 may assign a specified weight to the fixed element, by identifying whether the size of an area providing a link within the fixed element is greater than or equal to a threshold.

For example, when the fixed element does not include the frame (e.g., iframe) that is the child element, the electronic device 100 may assign a specified weight to the fixed element, by identifying an attribute (e.g., sponsored) related to a link in the fixed element.

Meanwhile, according to an embodiment of the disclosure, the electronic device 100 may calculate a first weight score for the fixed element, based on specified some attributes among attributes related to the fixed element. In addition, when the first weight score is greater than a threshold, the electronic device 100 may determine to remove the fixed element. In addition, when the first weight score is less than the threshold, the electronic device 100 may calculate a second weight score for the fixed element in consideration of at least some of the remaining some attributes among the attributes related to the fixed element. In addition, when the second weight score is greater than a threshold, the electronic device 100 may determine to remove the display of the fixed element. When the second weight score is less than the threshold, the electronic device 100 may determine to maintain the display of the fixed element.

According to an embodiment, a method for removing content in a web page in an electronic device may be provided. The method may include the operations of removing, from a web server, a web page being displayed or to be displayed on a screen of the electronic device, analyzing the web page, identifying, based on the analysis, at least one frame satisfying at least one condition among one or more frames in the web page, and removing the at least one frame and/or content in the at least one frame from the web page. The at least one condition may include at least one of whether the position of each of the at least one frame on the screen is fixed with respect to a scroll input to the web page or whether a domain address of a URL of the identified frame is different from a domain address of a URL of the web page.

According to an embodiment, the at least one condition may include whether the frame is a subframe of the uppermost frame of the web page.

According to an embodiment, the at least one condition may include whether an upper frame of the frame is a subframe of the uppermost frame.

According to an embodiment, the at least one condition may include a condition regarding a ratio at which an area where the frame is displayed occupies on the screen of the electronic device.

According to an embodiment, the method may further include the operation of calculating a score for the one or more frames, based on at least one weight corresponding to at least one condition for the one or more frames. The operation of identifying the at least one frame satisfying the at least one condition may include the operation of, as the score is less than a threshold, identifying the at least one frame satisfying the at least one condition for the content in the one or more frames. The operation of removing the at least one frame and/or the content in the at least one frame may include the operation of removing the at least one frame and/or the content in the at least one frame within the web page, based on the at least one condition for the one or more frames and the at least one condition for the content.

According to an embodiment, the at least one condition for the content in the one or more frames may include whether other content linked to the content is displayed through a new window different from a window of the web page, in response to a user input of selecting the content in the one or more frames.

According to an embodiment, the at least one condition for the content in the one or more frames may include whether a domain address corresponding to the other content linked to the content is different from the domain address of the web page.

According to an embodiment, the at least one condition for the content in the one or more frames may include a condition regarding a ratio at which an area where the content is displayed occupies within the one or more frames.

According to an embodiment, the operation of removing the at least one frame and/or the content in the at least one frame within the web page may include the operation of modifying code related to the display of the at least one frame and the content in the at least one frame.

According to an embodiment, the operation of removing the at least one frame and/or the content in the at least one frame within the web page may include the operation of moving a display position of the at least one frame and the content in the at least one frame to the outside of the screen of the electronic device.

According to an embodiment, the method may further include the operation of displaying the web page from which the at least one frame and/or the content in the at least one frame have not been removed, and the operation of removing the at least one frame and/or the content in the at least one frame may include the operation of removing the at least one frame and/or the content in the at least one frame, based on a user input to the web page from which the at least one frame and/or the content in the at least one frame have not been removed, or after the lapse of a predefined period of time after the displaying of the web page from which the at least one frame and/or the content in the at least one frame have not been removed.

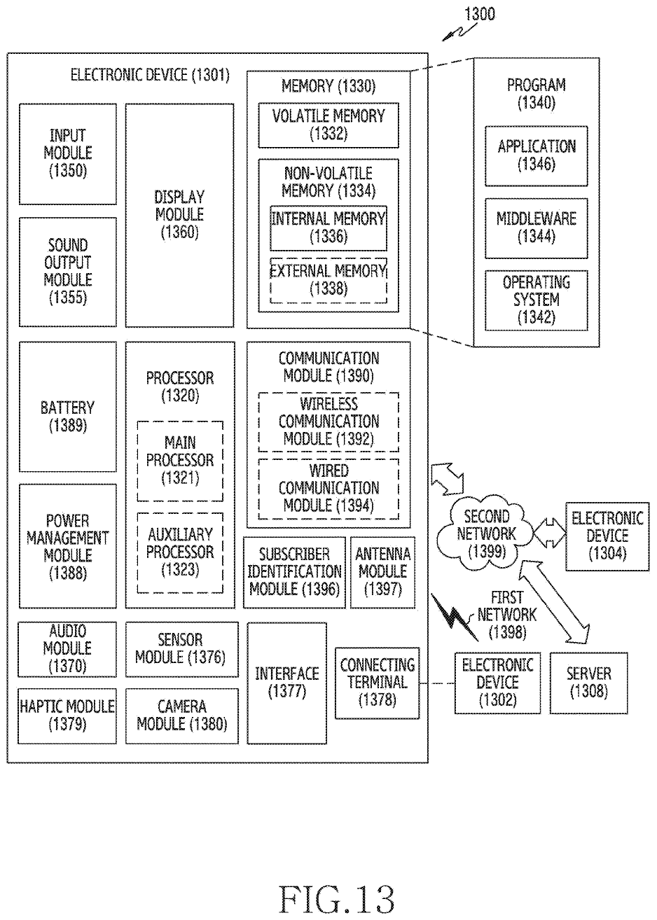

FIG. 13 is a block diagram illustrating an electronic device 1301 in a network environment 1300 according to an embodiment of the disclosure.

Referring to FIG. 13, the electronic device 1301 in the network environment 1300 may communicate with an electronic device 1302 via a first network 1398 (e.g., a short-range wireless communication network), or at least one of an electronic device 1304 or a server 1308 via a second network 1399 (e.g., a long-range wireless communication network). According to an embodiment, the electronic device 1301 may communicate with the electronic device 1304 via the server 1308. According to an embodiment, the electronic device 1301 may include a processor 1320, memory 1330, an input module 1350, a sound output module 1355, a display module 1360, an audio module 1370, a sensor module 1376, an interface 1377, a connecting terminal 1378, a haptic module 1379, a camera module 1380, a power management module 1388, a battery 1389, a communication module 1390, a subscriber identification module (SIM) 1396, or an antenna module 1397. In some embodiments, at least one of the components (e.g., the connecting terminal 1378) may be omitted from the electronic device 1301, or one or more other components may be added in the electronic device 1301. In some embodiments, some of the components (e.g., the sensor module 1376, the camera module 1380, or the antenna module 1397) may be implemented as a single component (e.g., the display module 1360).

The processor 1320 may execute, for example, software (e.g., a program 1340) to control at least one other component (e.g., a hardware or software component) of the electronic device 1301 coupled with the processor 1320, and may perform various data processing or computation. According to one embodiment, as at least part of the data processing or computation, the processor 1320 may store a command or data received from another component (e.g., the sensor module 1376 or the communication module 1390) in volatile memory 1332, process the command or the data stored in the volatile memory 1332, and store resulting data in non-volatile memory 1334. According to an embodiment, the processor 1320 may include a main processor 1321 (e.g., a central processing unit (CPU) or an application processor (AP)), or an auxiliary processor 1323 (e.g., a graphics processing unit (GPU), a neural processing unit (NPU), an image signal processor (ISP), a sensor hub processor, or a communication processor (CP)) that is operable independently from, or in conjunction with, the main processor 1321. For example, when the electronic device 1301 includes the main processor 1321 and the auxiliary processor 1323, the auxiliary processor 1323 may be adapted to consume less power than the main processor 1321, or to be specific to a specified function. The auxiliary processor 1323 may be implemented as separate from, or as part of the main processor 1321.

The auxiliary processor 1323 may control at least some of functions or states related to at least one component (e.g., the display module 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). According to an embodiment, the auxiliary processor 1323 (e.g., an image signal processor or a communication processor) may be implemented as part of another component (e.g., the camera module 1380 or the communication module 1390) functionally related to the auxiliary processor 1323. According to an embodiment, the auxiliary processor 1323 (e.g., the neural processing unit) may include a hardware structure specified for artificial intelligence model processing. An artificial intelligence model may be generated by machine learning. Such learning may be performed, e.g., by the electronic device 1301 where the artificial intelligence is performed or via a separate server (e.g., the server 1308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1330 may store various data used by at least one component (e.g., the processor 1320 or the sensor module 1376) of the electronic device 1301. The various data may include, for example, software (e.g., the program 1340) and input data or output data for a command related thererto. The memory 1330 may include the volatile memory 1332 or the non-volatile memory 1334.

The program 1340 may be stored in the memory 1330 as software, and may include, for example, an operating system (OS) 1342, middleware 1344, or an application 1346.

The input module 1350 may receive a command or data to be used by another component (e.g., the processor 1320) of the electronic device 1301, from the outside (e.g., a user) of the electronic device 1301. The input module 1350 may include, for example, a microphone, a mouse, a keyboard, a key (e.g., a button), or a digital pen (e.g., a stylus pen).

The sound output module 1355 may output sound signals to the outside of the electronic device 1301. The sound output module 1355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1360 may visually provide information to the outside (e.g., a user) of the electronic device 1301. The display module 1360 may include, for example, a display, a hologram device, or a projector and control circuitry to control a corresponding one of the display, hologram device, and projector. According to an embodiment, the display module 1360 may include a touch sensor adapted to detect a touch, or a pressure sensor adapted to measure the intensity of force incurred by the touch.

The audio module 1370 may convert a sound into an electrical signal and vice versa. According to an embodiment, the audio module 1370 may obtain the sound via the input module 1350, or output the sound via the sound output module 1355 or a headphone of an external electronic device (e.g., an electronic device 1302) directly (e.g., wiredly) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device (e.g., the electronic device 1302) directly (e.g., wiredly) or wirelessly. According to an embodiment, the interface 1377 may include, for example, a high-definition multimedia interface (HDMI), a universal serial bus (USB) interface, a secure digital (SD) card interface, or an audio interface.

A connecting terminal 1378 may include a connector via which the electronic device 1301 may be physically connected with the external electronic device (e.g., the electronic device 1302). According to an embodiment, the connecting terminal 1378 may include, for example, a HDMI connector, a USB connector, a SD card connector, or an audio connector (e.g., a headphone connector).

The haptic module 1379 may convert an electrical signal into a mechanical stimulus (e.g., a vibration or a movement) or electrical stimulus which may be recognized by a user via his tactile sensation or kinesthetic sensation. According to an embodiment, the haptic module 1379 may include, for example, a motor, a piezoelectric element, or an electric stimulator.

The camera module 1380 may capture a still image or moving images. According to an embodiment, the camera module 1380 may include one or more lenses, image sensors, image signal processors, or flashes.

The power management module 1388 may manage power supplied to the electronic device 1301. According to one embodiment, the power management module 1388 may be implemented as at least part of, for example, a power management integrated circuit (PMIC).

The battery 1389 may supply power to at least one component of the electronic device 1301. According to an embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the application processor (AP)) and supports a direct (e.g., wired) communication or a wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as Bluetooth™, wireless-fidelity (Wi-Fi) direct, or infrared data association (IrDA)) or the second network 1399 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The wireless communication module 1392 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., the millimeter wave (mmWave) band) to achieve, e.g., a high data transmission rate. The wireless communication module 1392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1392 may support various requirements specified in the electronic device 1301, an external electronic device (e.g., the electronic device 1304), or a network system (e.g., the second network 1399). According to an embodiment, the wireless communication module 1392 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 1397 may transmit or receive a signal or power to or from the outside (e.g., the external electronic device) of the electronic device 1301. According to an embodiment, the antenna module 1397 may include an antenna including a radiating element composed of a conductive material or a conductive pattern formed in or on a substrate (e.g., a printed circuit board (PCB)). According to an embodiment, the antenna module 1397 may include a plurality of antennas (e.g., array antennas). In such a case, at least one antenna appropriate for a communication scheme used in the communication network, such as the first network 1398 or the second network 1399, may be selected, for example, by the communication module 1390 (e.g., the wireless communication module 1392) from the plurality of antennas. The signal or the power may then be transmitted or received between the communication module 1390 and the external electronic device via the selected at least one antenna. According to an embodiment, another component (e.g., a radio frequency integrated circuit (RFIC)) other than the radiating element may be additionally formed as part of the antenna module 1397.

According to various embodiments, the antenna module 1397 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1301 and the external electronic device 1304 via the server 1308 coupled with the second network 1399. Each of the electronic devices 1302 or 1304 may be a device of a same type as, or a different type, from the electronic device 1301. According to an embodiment, all or some of operations to be executed at the electronic device 1301 may be executed at one or more of the external electronic devices 1302 or 1304 or the server 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, mobile edge computing (MEC), or client-server computing technology may be used, for example. The electronic device 1301 may provide ultra low-latency services using, e.g., distributed computing or mobile edge computing. In an embodiment, the external electronic device 1304 may include an internet-of-things (IoT) device. The server 1308 may be an intelligent server using machine learning and/or a neural network. According to an embodiment, the external electronic device 1304 or the server 1308 may be included in the second network 1399. The electronic device 1301 may be applied to intelligent services (e.g., smart home, smart city, smart car, or healthcare) based on 5G communication technology or IoT-related technology.

Referring to FIG. 13, the electronic device 1301 of FIG. 13 may correspond to the electronic device 100 of FIGS. 1 to 12. In addition, the processor 1320 may perform the operations of the electronic device 100 in FIGS. 1 to 12.

According to an embodiment, the processor 1320 may obtain code information of a web page to be displayed on a screen of the electronic device 100. The code information of the web page may include, for example, source code of hypertext markup language (HTML). The processor 1320 may obtain the code information of the web page to be displayed on the screen of the electronic device 100, based on a user input of calling a specific web page in an Internet browser. For example, the processor 1320 may obtain the code information of the web page, in response to at least one of a user input of inputting a specific address to an address bar of the Internet browser or a user input of selecting an object linked to a specific web page.

According to an embodiment, the processor 1320 may identify an attribute of a frame in the web page, based on the code information. The processor 1320 may identify attributes of the frame in the web page, based on codes in HTML information. The attribute of the frame in the web page may include, for example, an attribute regarding whether the position of the frame on the screen is fixed, an attribute regarding whether a domain address of the frame is different from a domain address of the web page, an attribute regarding a ratio at which an area where the frame is displayed occupies on the screen of the electronic device 100, an attribute regarding whether the frame is a subframe of the uppermost frame of the web page, and an attribute regarding whether an upper frame of the frame is a subframe of the web page.

According to an embodiment, the processor 1320 may determine whether to remove the frame and/or content in the frame, based on the attribute of the frame. The processor 1320 may identify a weight corresponding to each of the attributes of the frame by attributes, and calculate a weight score for the frame, based on the identified weight. The processor 1320 may calculate the weight score for the frame, based on at least one of the attributes of the frame. For example, when the position of the frame on the screen is fixed although a scroll input to the web page is received, the processor 1320 may assign a first weight to the frame. For example, when a domain address of the frame is different from a domain address of the web page, the processor 1320 may assign a second weight to the frame. For example, when a ratio at which an area where the frame is displayed occupies on the screen of the electronic device 100 is greater than or equal to a threshold, the processor 1320 may assign a third weight to the frame. For example, when the frame is a subframe of the uppermost frame of the web page, the processor 1320 may assign a fourth weight to the frame. For example, when an upper frame of the frame is a subframe of the web page, the processor 1320 may assign a fifth weight to the frame. In addition, for example, the processor 1320 may calculate the weight score for the frame, based on at least one of the first weight, the second weight, the third weight, the fourth weight, or the fifth weight. In this case, when considering some of the first weight, the second weight, the third weight, the fourth weight, and the fifth weight, the processor 1320 may identify only the attribute of the frame related to the considered weight.

According to an embodiment, when the weight score for the frame is greater than or equal to a threshold, the processor 1320 may determine that the frame and/or the content in the frame are removal targets. According to an embodiment, when the frame has a preset attribute, the processor 1320 may also determine that the frame and/or the content in the frame are the removal targets.

According to an embodiment, the processor 1320 may remove the frame and/or the content in the frame. By modifying code related to the display of the frame and/or the content in the frame, the processor 1320 may remove the frame and/or the content in the frame within the web page. For example, by modifying code for displaying the frame and the content being the removal targets among codes included in HTML, the processor 1320 may prevent the frame and/or the content in the frame from being displayed within the web page. For example, the processor 1320 may modify a code value, which indicates the size of a frame including removal target content, to ‘0.’ For example, the processor 1320 may modify a display attribute value for the content and/or the frame being the removal targets, to ‘none.’

According to an embodiment, the processor 1320 may remove an upper frame of the frame including the removal target content, together with the frame including the removal target content. For example, when the frame including the removal target content is a child frame, the upper frame of the frame including the removal target content is a parent frame of the frame being a removal target, and a ratio at which an area where the child frame is displayed occupies within the parent frame is greater than or equal to a threshold, the processor 1320 may remove the parent frame and the child frame within the web page, together.

According to an embodiment, when an event of calling a web page occurs, the processor 1320 may first display the web page from which removal target content has not been removed. In this case, for example, when a preset time elapses after the displaying of the web page from which the removal target content has not been removed, the processor 1320 may display the web page from which the removal target content has been removed. Alternatively, for example, after displaying the web page from which the removal target content has not been removed, the processor 1320 may display a graphical user interface (GUI) of inquiring whether to remove the removal target content, on the screen of the electronic device 100, and in response to receiving a user input to the GUI, the processor 1320 may display the web page from which the removal target content has been removed.

According to an embodiment, the processor 1320 may alternately display the web page from which the removal target content has not been removed and the web page from which the removal target content has been removed. For example, when the processor 1320 reloads the web page odd times, the processor 1320 may display the web page from which the removal target content has been removed, and when the processor 1320 reloads the web page even times, the processor 1320 may display the web page from which the removal target content has not been removed.

According to an embodiment, the processor 1320 may calculate a first weight score for a frame, based on a weight of an attribute of the frame. The processor 1320 may identify a weight corresponding to each of the attributes of the frame by attributes, and calculate the first weight score for the frame, based on the identified weight. The processor 1320 may calculate the first weight score for the frame, based on at least one of the attributes of the frame. For example, when the position of the frame on a screen is fixed although a scroll input to a web page is received, the processor 1320 may assign a first weight to the frame. For example, when a domain address of the frame is different from a domain address of the web page, the processor 1320 may assign a second weight to the frame. For example, when a ratio at which an area where the frame is displayed occupies on the screen of the electronic device 100 is greater than or equal to a threshold, the processor 1320 may assign a third weight to the frame. For example, when the frame is a subframe of the uppermost frame of the web page, the processor 1320 may assign a fourth weight to the frame. For example, when an upper frame of the frame is a subframe of the web page, the processor 1320 may assign a fifth weight to the frame. In addition, for example, the processor 1320 may calculate the first weight score for the frame, based on at least one of the first weight, the second weight, the third weight, the fourth weight, or the fifth weight. In this case, when considering some of the first weight, the second weight, the third weight, the fourth weight, and the fifth weight, the processor 1320 may identify only the attribute of the frame related to the considered weight.

According to an embodiment, the processor 1320 may determine whether the first weight score is greater than a threshold.

According to an embodiment, when the first weight score is less than the threshold, the processor 1320 may identify an attribute of content in the frame, based on the code information. The processor 1320 may identify attributes of the content in the frame in the web page, based on codes in HTML information. The attributes of the content in the frame may include, for example, at least one of an attribute regarding whether other content linked to the content in the frame is displayed through a new window, an attribute regarding whether a domain address of the other content linked to the content in the frame is different from a domain address of the web page, an attribute of a link to the content in the frame, an attribute regarding a ratio at which an area where the content is displayed occupies within the frame, an attribute regarding whether the content is scrollable within the frame, and an attribute regarding whether the content includes an object for frame removal.

According to an embodiment, the processor 1320 may calculate a second weight score for the frame, based on a weight for the attribute of the content. The processor 1320 may identify a weight corresponding to each of the attributes of the content in the frame by attributes, and calculate the second weight score for the frame, based on the identified weight. According to an embodiment, by adding the weight corresponding to the attribute of the content to the first weight score for the frame, the processor 1320 may calculate the second weight score for the frame.

For example, when the position of the frame on the screen is fixed although a scroll input to the web page is received, the processor 1320 may assign a first weight to the frame. For example, when the other content linked to the content in the frame is displayed through a new window, the processor 1320 may assign a sixth weight to the frame. For example, when a domain address of the other content linked to the content in the frame is different from a domain address of the web page, the processor 1320 may assign a seventh weight to the frame. For example, in accordance with an attribute value of a link to the content in the frame, the processor 1320 may assign an eighth weight to the frame. For example, in accordance with a ratio at which an area where the content is displayed occupies within the frame, the processor 1320 may assign a ninth weight to the frame. For example, when the content is not scrollable within the frame, the processor 1320 may assign a tenth weight to the frame. For example, when the content includes an object for frame removal, the processor 1320 may assign an eleventh weight to the frame.

In addition, for example, by adding at least one of the sixth weight, the seventh weight, the eighth weight, the ninth weight, the tenth weight, or the eleventh weight to the first weight score for the frame, the processor 1320 may calculate the second weight score for the frame. In this case, when considering some of the sixth weight, the seventh weight, the eighth weight, the ninth weight, the tenth weight, or the eleventh weight, the processor 1320 may identify only the attribute of the content related to the considered weight.

According to an embodiment, the processor 1320 may determine whether the second weight score is greater than a threshold. The threshold compared to the second weight score may be the same as the threshold compared to the first weight score, but is not limited thereto.

According to an embodiment, when the second weight score is greater than the threshold, the processor 1320 may remove the frame and the content in the frame from the web page.

According to an embodiment, when the second weight score is less than the threshold, the processor 1320 may maintain the frame and the content in the frame within the web page.

According to an embodiment, before displaying the web page on the screen of the electronic device 100, the processor 1320 may effectively determine unnecessary content, based on the code information of the web page. In addition, only when the first weight score being based on the attribute of the frame is less than the threshold, the processor 1320 may consider the attribute of the content in the frame. Accordingly, when determining in real time and removing unnecessary content in the web page, the processor 1320 may determine the unnecessary content more efficiently and remove the unnecessary content seamlessly within the web page.

According to an embodiment, an electronic device for removing content in a web page may be provided. The electronic device may include a display, memory for storing instructions, and a processor operatively connected to the display and the memory and executing the instructions. When executed by the processor, the instructions in the memory may cause the electronic device to at least remove, from a web server, a web page being displayed or to be displayed on a screen of the electronic device, analyze the web page, identify, based on the analysis, at least one frame satisfying at least one condition among one or more frames in the web page, and remove the at least one frame and/or content in the at least one frame from the web page. The at least one condition may include at least one of whether the position of each of the at least one frame on the screen is fixed with respect to a scroll input to the web page or whether a domain address of a URL of the identified frame is different from a domain address of a URL of the web page.

According to an embodiment, the at least one condition may include whether the frame is a subframe of the uppermost frame of the web page.

According to an embodiment, the at least one condition may include whether an upper frame of the frame is a subframe of the uppermost frame.

According to an embodiment, the at least one condition may include a condition regarding a ratio at which an area where the frame is displayed occupies on the screen of the electronic device.

According to an embodiment, when executed by the processor, the instructions in the memory may cause the electronic device to calculate a score for the one or more frames, based on at least one weight corresponding to at least one condition for the one or more frames, identify the at least one frame satisfying the at least one condition for the content in the one or more frames as the score is less than a threshold, and remove the at least one frame and/or the content in the at least one frame within the web page, based on the at least one condition for the one or more frames and the at least one condition for the content.

According to an embodiment, the at least one condition for the content in the one or more frames may include whether other content linked to the content is displayed through a new window different from a window of the web page, in response to a user input of selecting the content in the one or more frames.

According to an embodiment, the at least one condition for the content in the one or more frames may include whether a domain address corresponding to the other content linked to the content is different from the domain address of the web page.

According to an embodiment, the at least one condition for the content in the one or more frames may include a condition regarding a ratio at which an area where the content is displayed occupies within the one or more frames.

According to an embodiment, a computer-readable recording medium recording a program for executing a method by a computer may be provided. The method may include the operations of removing, from a web server, a web page being displayed or to be displayed on a screen of the electronic device, analyzing the web page, identifying, based on the analysis, at least one frame satisfying at least one condition among one or more frames in the web page, and removing the at least one frame and/or content in the at least one frame from the web page. The at least one condition may include at least one of whether the position of each of the at least one frame on the screen is fixed with respect to a scroll input to the web page or whether a domain address of a URL of the identified frame is different from a domain address of a URL of the web page.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1340) including one or more instructions that are stored in a storage medium (e.g., internal memory 1336 or external memory 1338) that is readable by a machine (e.g., the electronic device 1301). For example, a processor (e.g., the processor 1320) of the machine (e.g., the electronic device 1301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for removing content in a web page in an electronic device, the method comprising:
removing, from a web server, a web page being displayed or to be displayed on a screen of the electronic device;
analyzing the web page;
identifying, based on the analysis, at least one frame satisfying at least one condition among one or more frames in the web page; and
removing the at least one frame or content in the at least one frame from the web page,
wherein the at least one condition comprises at least one of whether a position of each of the at least one frame on the screen is fixed with respect to a scroll input to the web page or whether a domain address of a universal resource locator (URL) of the identified frame is different from a domain address of a URL of the web page.

2. The method of claim 1, wherein the at least one condition comprises whether the frame is a subframe of the uppermost frame of the web page.

3. The method of claim 2, wherein the at least one condition comprises whether an upper frame of the frame is a subframe of the uppermost frame.

4. The method of claim 1, wherein the at least one condition comprises a condition regarding a ratio at which an area where the frame is displayed occupies on the screen of the electronic device.

5. The method of claim 1, further comprising:
calculating a score for the one or more frames, based on at least one weight corresponding to at least one condition for the one or more frames,
wherein the identifying of the at least one frame satisfying the at least one condition comprises:
if the score is less than a threshold, identifying the at least one frame satisfying the at least one condition for the content in the one or more frames, and
removing the at least one frame or the content in the at least one frame comprises removing the at least one frame or the content in the at least one frame within the web page, based on the at least one condition for the one or more frames and the at least one condition for the content.

6. The method of claim 5, wherein the at least one condition for the content in the one or more frames comprises whether other content linked to the content is displayed through a new window different from a window of the web page, in response to a user input of selecting the content in the one or more frames.

7. The method of claim 6, wherein the at least one condition for the content in the one or more frames comprises whether a domain address corresponding to the other content linked to the content is different from the domain address of the web page.

8. The method of claim 5, wherein the at least one condition for the content in the one or more frames comprises a condition regarding a ratio at which an area where the content is displayed occupies within the one or more frames.

9. The method of claim 1, wherein the removing of the at least one frame and/or the content in the at least one frame within the web page comprises modifying code related to the display of the at least one frame and the content in the at least one frame.

10. The method of claim 1, wherein the removing of the at least one frame or the content in the at least one frame within the web page comprises moving a display position of the at least one frame and the content in the at least one frame to an outside of the screen of the electronic device.

11. The method of claim 1, further comprising:
displaying the web page from which the at least one frame and/or the content in the at least one frame have not been removed,
wherein the removing of the at least one frame or the content in the at least one frame comprises:
removing the at least one frame or the content in the at least one frame, based on a user input to the web page from which the at least one frame and/or the content in the at least one frame have not been removed, or
after a lapse of a predefined period of time after the displaying of the web page from which the at least one frame and/or the content in the at least one frame have not been removed.

12. An electronic device for removing content in a web page, the electronic device comprising:
a display;
memory, comprising one or more storage media, storing instructions; and
one or more processors operatively connected to the display and the memory,
wherein the instructions, when executed by the one or more processors individually or collectively, cause the electronic device to:
remove, from a web server, a web page being displayed or to be displayed on a screen of the electronic device,
analyze the web page,
identify, based on the analysis, at least one frame satisfying at least one condition among one or more frames in the web page, and
remove the at least one frame or content in the at least one frame from the web page, and
wherein the at least one condition comprises at least one of whether a position of each of the at least one frame on the screen is fixed with respect to a scroll input to the web page or whether a domain address of a universal resource locator (URL) of the identified frame is different from a domain address of a URL of the web page.

13. The electronic device of claim 12, wherein the at least one condition comprises whether the frame is a subframe of the uppermost frame of the web page.

14. The electronic device of claim 13, wherein the at least one condition comprises whether an upper frame of the frame is a subframe of the uppermost frame.

15. The electronic device of claim 12, wherein the instructions, when executed by the one or more processors individually or collectively, cause the electronic device to:
calculate a score for the one or more frames, based on at least one weight corresponding to at least one condition for the one or more frames,
wherein the identifying of the at least one frame satisfying the at least one condition comprises:
if the score is less than a threshold, identifying the at least one frame satisfying the at least one condition for the content in the one or more frames, and
removing the at least one frame or the content in the at least one frame comprises removing the at least one frame or the content in the at least one frame within the web page, based on the at least one condition for the one or more frames and the at least one condition for the content.

16. The electronic device of claim 15, wherein the at least one condition for the content in the one or more frames comprises whether other content linked to the content is displayed through a new window different from a window of the web page, in response to a user input of selecting the content in the one or more frames.

17. The electronic device of claim 16, wherein the at least one condition for the content in the one or more frames comprises whether a domain address corresponding to the other content linked to the content is different from the domain address of the web page.

18. The electronic device of claim 15, wherein the at least one condition for the content in the one or more frames comprises a condition regarding a ratio at which an area where the content is displayed occupies within the one or more frames.

19. One or more non-transitory computer-readable storage media storing one or more programs including computer-executable instructions that, when executed by one or more processors of an electronic device individually or collectively, cause the electronic device to perform operations, the operations comprising:
removing, from a web server, a web page being displayed or to be displayed on a screen of the electronic device;
analyzing the web page;
identifying, based on the analysis, at least one frame satisfying at least one condition among one or more frames in the web page; and
removing the at least one frame or content in the at least one frame from the web page,
wherein the at least one condition comprises at least one of whether a position of each of the at least one frame on the screen is fixed with respect to a scroll input to the web page or whether a domain address of a universal resource locator (URL) of the identified frame is different from a domain address of a URL of the web page.

20. The one or more non-transitory computer-readable storage media of claim 19, wherein the at least one condition comprises whether the at least one frame is a subframe of the uppermost frame of the web page.
